(19) United States
(12) Patent Application Publication
(10) Pub. No.: US 2006/0085386 A1
(43) Pub. Date: Apr. 20, 2006

(54) Two pass calculation to optimize formula calculations for a spreadsheet

(75) Inventors: Lakshmi Narayanan Thanu, Sammamish, WA (US); Peter Eberhardy, Seattle, WA (US); Xiaohong Yang, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/969,381

(22) Filed: Oct. 19, 2004

(51) Int. Cl. G06F 17/30; G06F 17/00; G06F 17/24

(52) U.S. Cl. 707/2; 715/503; 707/104.1

(57) ABSTRACT

Current cell values are provided to a client using two-passes. When a first request to provide values is received during a first pass, default values are provided to the client. Upon receiving each value request, the formula parameters are collected that are associated with the cell. The formula parameters are parsed to determine data that is to be retrieved from a database. Once the locations for all of the data to be retrieved has been determined, the data is retrieved from a database in as few as hits as possible. After obtaining the current values from the database, the client is informed to request the values a second time. When the second request to provide values is received, the client is provided with the calculated values during the second pass.

### BACKGROUND OF THE INVENTION

Online analytical processing (OLAP) is an integral part of most data warehouse and business analysis systems. OLAP services provide for fast analysis of multidimensional information. For this purpose, OLAP services provide for multidimensional access and navigation of the data in an intuitive and natural way, providing a global view of data that can be “drilled down” into particular data of interest. Speed and response time are important attributes of OLAP services that allow users to browse and analyze data online in an efficient manner. Further, OLAP services typically provide analytical tools to rank, aggregate, and calculate lead and lag indicators for the data under analysis.

In OLAP, information is viewed conceptually as cubes, consisting of dimensions, levels, and measures. In this context, a dimension is a structural attribute of a cube that is a list of members of a similar type in the user's perception of the data. Typically, there are hierarchy levels associated with each dimension. For example, a time dimension may have hierarchical levels consisting of days, weeks, months, and years, while a geography dimension may have levels of cities, states/provinces, and countries. Dimension members act as indices for identifying a particular cell or range of cells within a multidimensional array. Each cell contains a value, also referred to as a measure, or measurement. Spreadsheets may require data from a cube. To access the cube data, the spreadsheet must request the data. It is important that this request be performed in an efficient manner.

### SUMMARY OF THE INVENTION

Embodiments of the present invention are related to a method and system for optimizing formula calculations for a spreadsheet.

According to one aspect of the invention, two-passes are used to provide current cell values to a client in order to reduce the number of database hits and improve the overall performance during report rendering. During a first pass, a client requests current cell values. Instead of responding to each request during the first pass with the current cell values, default cell values are provided to the client. The default values may be any value that satisfies the client's request for values. Upon receiving each request during the first pass, the formula parameters associated with each cell are parsed to determine the data that is to be retrieved from a database. For example, the formula parameters may identify locations of data within an OLAP cube. Once all of the requests are received and the location of the data is identified, the data is retrieved from a database in as few as hits as possible. After retrieving the current values for each of the cells, the client is instructed to request the values for a second time. When each of the second requests are received during the second pass, the client is provided with the retrieved values.

### BRIEF DESCRIPTION OF THE DRAWINGS

FIG. 1 is an exemplary computing device that may be used in exemplary embodiments of the present invention;

FIG. 2 shows a two-pass calculation state diagram;

FIG. 3 illustrates two-pass calculation system utilizing OLAP data;

FIG. 4 illustrates an exemplary OLAP cube;

FIGS. 5A-5C illustrates a free-form report; and

FIG. 6 illustrates a process for a two-pass calculation to reduce database hits, in accordance with aspects of the invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings associated herein, unless the context clearly dictates otherwise. The term “cube” refers to a set of data that is organized and summarized into a multidimensional structure defined by a set of dimensions and measures.

The term “dimension” refers to a structural attribute of a cube, which is an organized hierarchy of categories (levels) that describe data in a fact table. These categories typically describe a similar set of members upon which the user wants to base an analysis. For example, a geography dimension might include levels for Country, Region, State or Province, and City.

The term “hierarchy” refers to a logical tree structure that organizes the members of a dimension such that each member has one parent member and zero or more child members.

The term “level” refers to the name of a set of members in a dimension hierarchy such that all members of the set are at the same distance from the root of the hierarchy. For example, a time hierarchy may contain the levels Year, Month, and Day.

The term “measure” refers to values within a cube that are based on a column in the cube's fact table store and are usually numeric. Measures are the central values that are aggregated and analyzed.

The term “member” refers to an item in a dimension representing one or more occurrences of data. A member can be either unique or non-unique. For example, 1997 and 1998 represent unique members in the year level of a time dimension, whereas January represents non-unique members in the month level because there can be more than one January in the time dimension if the cube contains data for more than one year.

The term “OLAP” refers to Online Analytical Processing. OLAP is a technology that uses multidimensional structures to provide rapid access to data for analysis. The source data for OLAP is commonly stored in data warehouses in a relational database.

The term “tuple(s)” refers to an ordered collection of members from different dimensions. For example, (Boston, [1995]) is a tuple formed by members of two dimensions: Geography and Time.

Two Pass Calculation System Level Overview

Generally, embodiments of the present invention are related to a method and system for optimizing formula calculations for a spreadsheet. Two-passes are used to provide current cell values to a client. During a first pass, the client requests current cell values. Instead of responding to the client with the current values, default values are provided to the client. The default values may be any value that satisfies the client's request for values. Upon receiving each request for a value during the first pass, the formula parameters associated with each cell are parsed to determine the data that is to be retrieved from a database. Once all of the requests are received and the location of the data is identified, the data is retrieved from a database in as few as hits as possible. After retrieving the current values for each of the cells, the client is instructed to request the values for a second time. When each of the requests is received during the second pass, the client is provided with the values retrieved during the first pass. This two-pass approach lowers the cost of processing these requests as compared to a one-pass approach. A one-pass approach results in a linear cost to determine the value for each cell as the processing is in series. A two-pass approach may result in a significant savings.

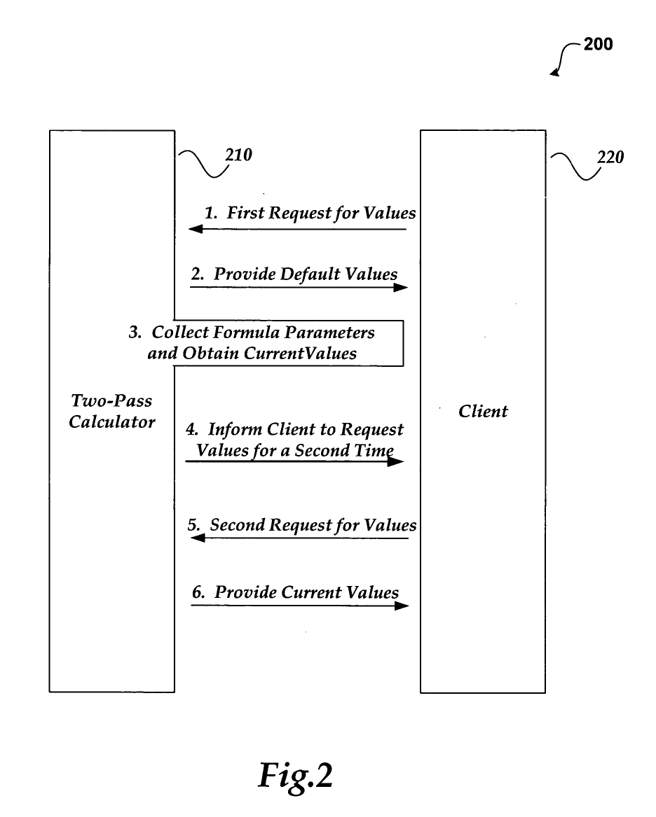

FIG. 2 illustrates a two-pass calculation state diagram, in accordance with aspects of the present invention. As illustrated, the state diagram includes two-pass calculator 210 and client 220.

Client 220 may be any program that requires data from an external database. According to one embodiment, client 220 is a spreadsheet program that requires data from an OLAP cube. Client 220 initially sends a set of requests to two-pass calculator 220 requesting values for cells that need to be refreshed. Each request is typically performed serially by client 220. If two-pass calculator 210 were to start processing each request immediately, the cost to determine the value associated with each cell becomes linear since the processing of the cells by the client is in series.

When each request for a cell value is received during the first pass, two-pass calculator 210 parses the formula parameters associated with the cell to determine the data to be retrieved form a database and provides client 220 with a default value for the request. Parsing the formula parameters includes examining each parameter to determine if it identifies data within a database that is to be retrieved. The default values are temporary values that act as a placeholder in the cell until the current values may be calculated. According to one embodiment of the invention, the default values are “0.” The default values may be other values as well. For example, the default value may be the value currently in the cell, an estimate of the current value, a string indicating the value is not accurate (i.e. “NULL”, “DEFAULT”) and the like. Generally, any default value that requires little or no calculations may be used.

Once all of the requests for values have been received during the first pass, two-pass calculator 210 retrieves the data from the database(s). The data retrieved from the database, such as OLAP cube data, is retrieved in as few as hits to the database as possible. According to one embodiment, all of the data from the database is retrieved using a single query.

After retrieving the values, the client is informed to request the values for a second time. According to one embodiment, two-pass calculator 210 marks each cell that was included in the first request for values as “dirty.” In response to the cell being marked “dirty,” client 220 requests the values to be refreshed.

Two-pass calculator 210 provides client 220 with the current values in response to the second request. In the second pass, each current value may be provided serially since the current values were retrieved in response to the set of first requests received during the first pass.

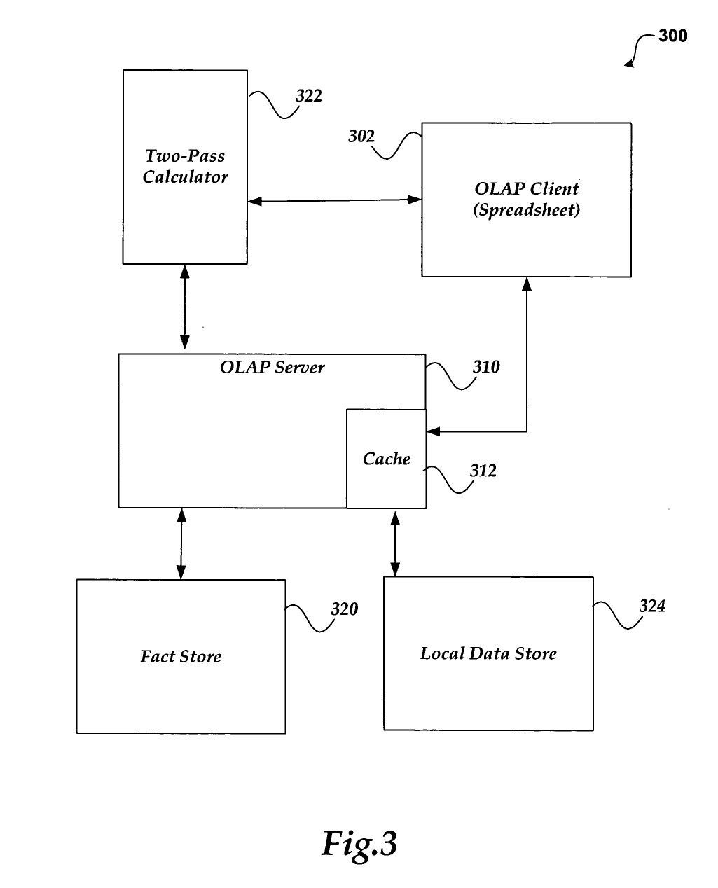

FIG. 3 illustrates two-pass calculation system utilizing OLAP data, in accordance with aspects of the invention. As illustrated, the two-pass system includes OLAP client 302, two-pass calculator 322, OLAP server 310, local data store 314, and fact data store 320, all of which may interact with the data within an OLAP cube(s).

OLAP client 302 is an application program that uses the services of an OLAP system. OLAP client 302 may be any type of application that interacts with the OLAP system and queries an OLAP cube for data. For example OLAP client 302 may be a spreadsheet, a data mining application, a data warehousing application, a reporting application, and the like. According to one embodiment of the invention, OLAP client 302 is a spreadsheet program, such as the Excel® spreadsheet program by Microsoft Corporation. OLAP client 302 typically interacts with OLAP server 310 by issuing OLAP queries requesting data from a cube. These queries are parsed into a request for data from the cube, and the request is passed to the OLAP server 310.

Two-pass calculator 322 interacts with OLAP client 302 and OLAP server 310. According to one embodiment, two-pass calculator 322 is a plug-in to client application 302. According to another embodiment, the functionality of two-pass calculator 322 may be included within another program. During a first pass, two-pass calculator 322 receives a first set of requests to update cells within spreadsheet (302) and provides each request with a default value until two-pass calculator 322 may collect all of the requests in the first set of requests. Once two-pass calculator 322 has gathered all of the requests it queries OLAP server 310 to access the cube data referenced within each of the requests. For each spreadsheet cell that accesses OLAP data, a tuple is generated to identify data within an OLAP cube. According to one embodiment, the number of members within each tuple is constant across spreadsheet cells. For example, if a total of six cube dimensions are accessed by cells within the spreadsheet, then each tuple will contain six members. When the spreadsheet cell does not access a particular dimension, a default member is placed within the tuple. Once the tuples are created, two-pass calculator 322 consolidates the tuples to form a consolidated query to access the cube data and reduce the number of hits. Instead of hitting the OLAP cube for each requested cell value, the cube is hit fewer times, thereby reducing the time required to obtain the data from the cube. Once the data is obtained, two-pass calculator 322 calculates the cell value for each requested value, stores the values, and marks the cells associated with each request in the first set of requests within client 302 as dirty. In response to the cells being marked dirty, client 302 makes a second set of requests to two-pass calculator 322 to obtain the cell values. In response to the second request, two-pass calculator returns the current values, which were temporarily stored, to client 302.

OLAP server 310 receives the query and controls the processing of the query. In one embodiment of the invention, OLAP server 310 maintains a local data store 314 that contains the data used to answer queries. In one embodiment of the invention, the OLAP server 310 is a version of the SQL Server OLAP product from Microsoft Corporation.

Local data store 314 contains records describing the cells that are present in a multidimensional database, with one record used for each cell that has measurement data present (i.e. no records exist for those cells having no measurement data). In an embodiment of the invention, local data store 314 is a relational database, such as SQL Server. In alternative embodiments of the invention, database systems such as Oracle, Informix or Sybase can be used. The invention is not limited to any particular type of relational database system.

OLAP server 310 populates local data store 314 by reading data from fact data store 320. Fact data store 320 is also a relational database system. In one embodiment of the invention, the system used is the SQL Server Database from Microsoft Corporation. In alternative embodiments of the invention, any type of relational database system may be used. For example, database systems such as Oracle, Informix or Sybase can be used.

According to one embodiment, records are stored in a relational table. This table can be indexed based on the dimensional paths of the record to allow rapid access to cell measurement data contained in the record.

In one embodiment of the invention, OLAP server 310 maintains a cache 312 of records. In this embodiment, cache 312 maintains data records that have been recently requested, or those data records that are frequently requested. Maintaining cell record data in a cache may help provide quicker responses to queries that can be satisfied by records appearing in the cache.

Exemplary Cube and Dimension

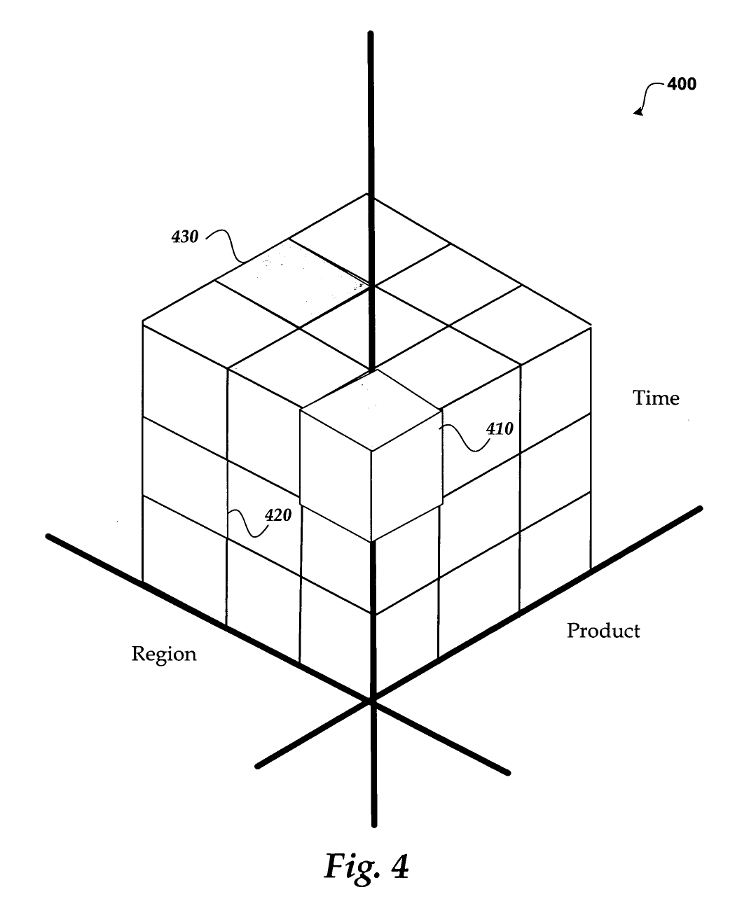

FIG. 4 illustrates an exemplary OLAP cube, in accordance with aspects of the present invention.

In an OLAP data model, information is viewed conceptually as cubes that consist of descriptive categories (dimensions) and quantitative values (measures). The multidimensional data model makes it easier for users to formulate complex queries, arrange data on a report, switch from summary to detail data, and filter or slice data into meaningful subsets. For example, typical dimensions in a cube containing sales information may include time, geography, product, channel, organization, and scenario (budget or actual). Typical measures may include dollar sales, unit sales, inventory, headcount, income, and expense.

Within each dimension of an OLAP data model, data can be organized into a hierarchy that represents levels of detail on the data. For example, within the time dimension, there may be levels for years, months, and days. Similarly, a geography dimension may include: country, region, state/province, and city levels. A particular instance of the OLAP data model would have the specific values for each level in the hierarchy. A user viewing OLAP data can move up or down between levels to view information that is either more or less detailed.

The cube is a specialized database that is optimized to combine, process, and summarize large amounts of data in order to provide answers to questions about that data in the shortest amount of time. This allows users to analyze, compare, and report on data in order to spot business trends, opportunities, and problems. A cube uses pre-aggregated data instead of aggregating the data at the time the user submits a query.

Hierarchies and levels can be defined for dimensions within the cube. Hierarchies typically display the same data in different formats such as time data can appear as months or quarters. Levels typically allow the data to be “rolled up” into increasing less detailed information such as in a Region dimension where cities roll-up into states which roll-up into regions which roll-up into counties and so forth. This allows the user to “drill-up” or “drill-down” to see the data in the desired detail. Levels and hierarchies for a star schema are derived from the columns in a dimension table. In a snowflake schema, they are typically derived from the data in related tables.

The exemplary OLAP cube illustrated includes three dimensions. The Region dimension may many different levels. For example, the region dimension may include a country level, a geographic area level (NE, NW, SE, SW, and the like), and a city level. The Products dimension may also include multiple levels. For example, has all, category and product. Finally, the third dimension, the Time dimension may include multiple levels, such as year, quarter, and month). The cube may also include multiple measures. For example, unit sales and purchases. This cube is presented to provide a reference example of how a cube is used. It will be appreciated that the OLAP cubes maintained by various embodiments of the invention may have more or fewer dimensions than in this example, and that the OLAP cube may have more or fewer hierarchy levels than in this exemplary example.

Each data cell in a multidimensional database is uniquely identified by specifying a coordinate on each dimension. In order to uniquely identify a particular member within the OLAP cube, each of the members from the root node to the leaf node for the member is specified forming a tuple. A tuple may contain one or more members. According to one embodiment, each tuple contains the same number of members to access the desired data within the cube.

Queries to access different members within cube 400 may be consolidated. For example, the queries to access data within cell 410, cell 420, and cell 430 may be consolidated into a single query. Instead of accessing cube with three different database hits, a single database hit is incurred when the queries are consolidated.

Free-Form Reports and Structured Reports

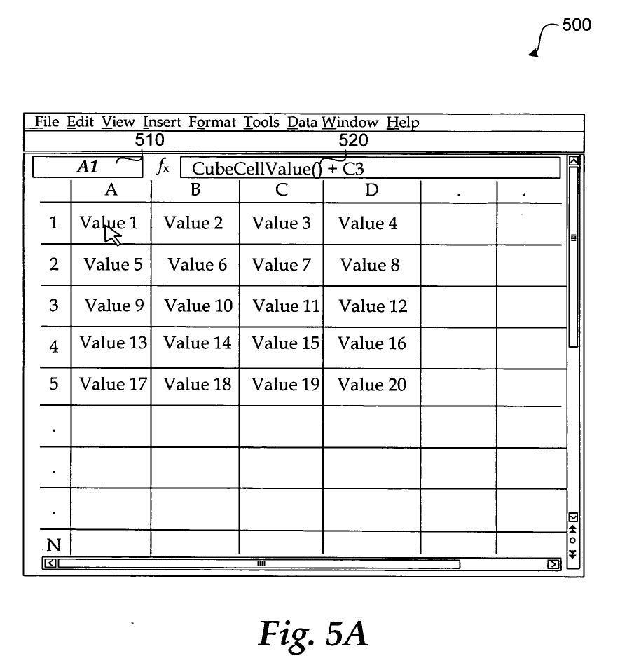

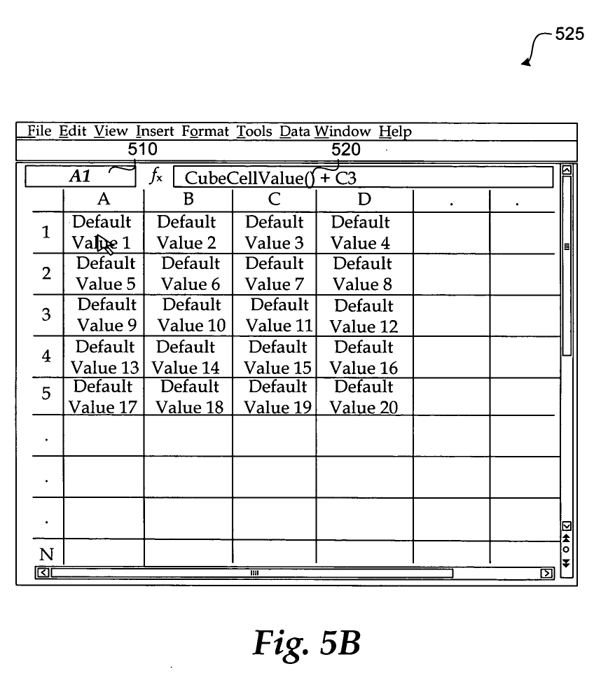

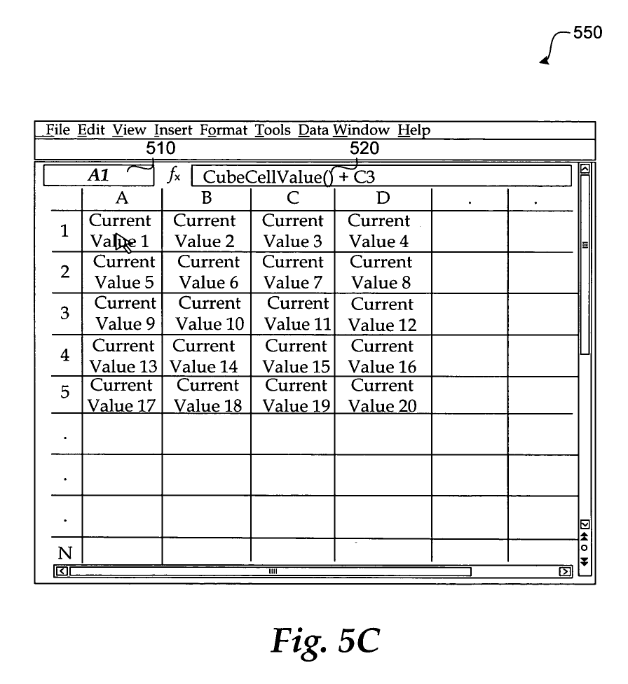

FIGS. 5A-5C illustrate a free-form report, in accordance with aspects of the invention.

A report consists of a connection to a data source, coupled with a layout that organizes the data values. The layout can be structured or free-form. Many aspects of report layout and member selection are the same between structured and free-form reports.

Unlike a structured report, free-form reports do not use structured report segments and a data grid. In a free-form report individual cell formulas connect each cell to the connection. Row, column, and page cells retrieve dimension member names from the connection. Data cells retrieve values. Report cells do not need to form a contiguous block. Formulas may be placed anywhere within the worksheet. For example, formulas may be placed into the middle of the report and rows and columns can be inserted or individual cells moved freely on the worksheet. Using free-form reports mixed hierarchies can be arranged in a single report axis making it easy to create asymmetrical reports. A single report can also integrate members and values from multiple connections, including cubes from different servers.

A structured report, on the other hand, does not allow changes to the worksheet. A free-form report contains individual cells, each of which may contain an independent function that accesses a value within a cube. Because each cell contains an independent function, a user is allowed to move cells around, insert rows and columns, interleave formulas, or any number of combinations.

As illustrated in report 500, each value within the report may include a formula. For example, cell A1 (see 510) contains the formula: CubeCellValue( )+C3 (520). One or more of the cells may require cube data to update its value. When a refresh is first made to the report, each cell within the report is initially set to a default value (See FIG. 5B). According to one embodiment, the default value is “0.” Other values may also be used. For example, each cell could be refreshed with its current value. In this particular example, each cell within the first five rows (1-5) and first five columns (A-D) are set to zero. Once it has been determined which cells require data from a cube, a query is created that retrieves the data from the cube. According to one embodiment, a consolidated query is created that retrieves the data from a cube in a single call. This substantially reduces the database hits. Any further calculations using the returned data to determine the cell values is then completed.

FIG. 5C illustrates the report with the current values that are returned during the second refresh request.

Process for Two-Pass Calculation

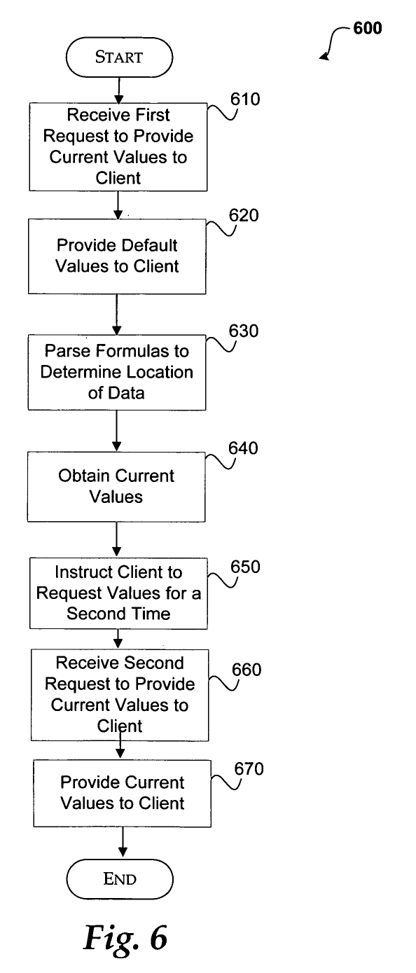

FIG. 6 illustrates a process for a two-pass calculation to reduce database hits, in accordance with aspects of the invention. After a start block, the process flows to block 610, where a first request to provide current values to a client is received. Moving to block 620, default values are provided to the client. Transitioning to block 630, the formula parameters associated with each request are parsed to determine the location of data that is to be retrieved. Transitioning to block 640, a database request is made to retrieve the data identified at block 630. Instead of retrieving the data from the database for each individual request, a consolidated query is used to obtain data for each of the cells. Flowing to block 650, the client is instructed to request the values for a second time. According to one embodiment, the cells on the client are marked “dirty.” At block 660, in response to the cells being marked dirty, the client sends a second request to obtain the current values. Moving to block 670, the current values are provided to the client. The process then moves to an end block.

Illustrative Operating Environment

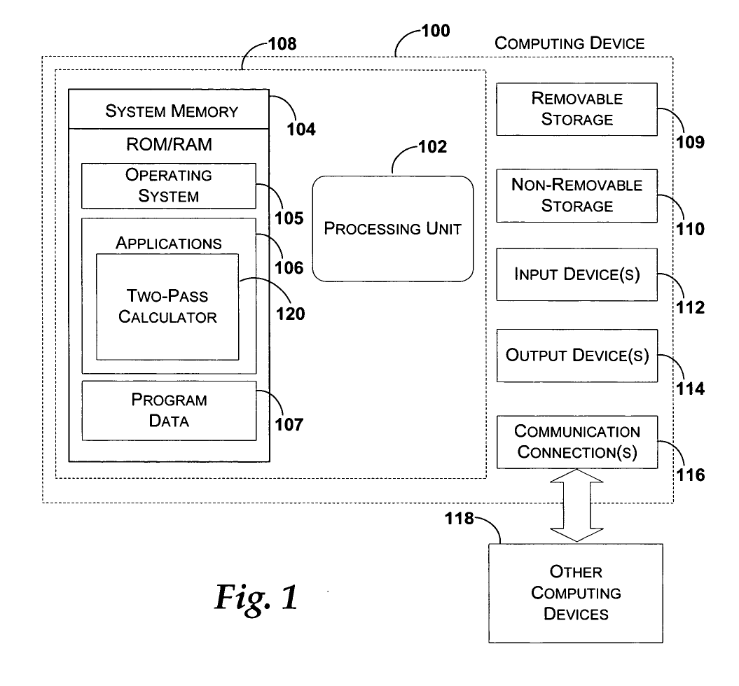

With reference to FIG. 1, one exemplary system for implementing the invention includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 may include two-pass calculator 120. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 may also contain communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer implemented method for optimizing formula calculations for a spreadsheet including cells, comprising:
receiving a first set of requests, wherein each of the requests is requesting a current value for a cell;
returning a default value to each of the cells in the first set of requests;
collecting formula parameters for each cell in the first set of requests;
calculating the current value for each of the cells in the first set of requests;
receiving a second set of requests; wherein each of the requests within the second set of requests corresponds to each of the requests within the first set of requests; and
providing the current value for each request, wherein the current value was calculated before receiving the second set of requests.

2. The method of claim 1, wherein receiving the first set of requests comprises serially receiving each of the requests within the first set of requests.

3. The method of claim 1, wherein collecting the formula parameters for each cell in the first set of requests comprises obtaining a location of data within a database and determining any calculations that are to be performed using the data.

4. The method of claim 3, further comprising creating a consolidated query that is used to obtain data associated with more than one cell from the database.

5. The method of claim 3, further comprising marking the cells corresponding to the in first set of requests dirty after the current values have been calculated.

6. The method of claim 3, further comprising utilizing an OLAP service to retrieve data from an OLAP cube and calculating the current value for each of the cells using the data retrieved from the OLAP cube.

7. The method of claim 1, wherein collecting the formula parameters for each cell in the first set of requests comprises parsing each cell within a spreadsheet to determine whether the cell requires data from an OLAP cube.

8. The method of claim 7, wherein the spreadsheet comprises a free-form report, wherein the free form report allows formulas within each of the cells.

9. A computer-readable medium having computer executable instructions for optimizing formula calculations for a report that include cells, comprising:
receiving a first set of requests, wherein each of the requests is requesting a current value for a cell;
returning a default value to each of the cells in the first set of requests;
collecting formula parameters for each request;
obtaining data from a database using a consolidated query;
calculating the current value for each of the cells in the first set of requests using the obtained data;
receiving a second set of requests; wherein each of the requests within the second set of requests corresponds to each of the requests within the first set of requests; and
providing the current value for each request as it is received.

10. The computer-readable medium of claim 9, wherein receiving the first set of requests comprises serially receiving each of the requests.

11. The computer-readable medium of claim 9, wherein collecting the formula parameters comprises determining a location of data within an OLAP cube.

12. The computer-readable medium of claim 11, further comprising determining any calculations that are to be performed using the data located within the OLAP cube.

13. The computer-readable medium of claim 10, further comprising marking the cells to initiate the second set of requests.

14. The computer-readable medium of claim 11, further comprising utilizing an OLAP service to retrieve data from the OLAP cube and calculating the current value for each of the cells using the data retrieved from the OLAP cube.

15. The computer-readable medium of claim 10, wherein collecting the formula parameters for each cell in the first set of requests comprises parsing each cell within a spreadsheet to determine whether the cell requires data from an OLAP cube.

16. A system for optimizing formula calculations, comprising:
a database;
a spreadsheet containing cells, wherein at least two of the cells reference data within the database; and a a two-pass calculator configured to:
receive a first set of requests, wherein each of the requests is requesting a current value for a cell within the spreadsheet;
return a default value in response to each of the requests;
collect formula parameters for each request;
form a consolidated query to obtain data from the database such that the consolidated query retrieves data for more than one cell;
obtain the data from the database using the consolidated query;
calculate the current value for each of the cells;
receive a second set of requests; wherein each of the requests within the second set of requests corresponds to each of the requests within the first set of requests; and
provide the current value for each request as it is received.

17. The system of claim 16, wherein receiving the first set of requests comprises serially receiving each of the requests.

18. The system of claim 16, wherein collecting the formula parameters comprises determining a location of data within an OLAP cube.

19. The system of claim 17, further comprising marking the cells such that the spreadsheet initiates the second set of requests.

20. The system of claim 18, further comprising an OLAP service configured to retrieve data from the OLAP cube.

21. The system of claim 17, wherein forming the consolidated query to obtain data from the database comprises forming the consolidated query to request data associated with each of the cells.
